(19) United States
(12) Patent Application Publication
(10) Pub. No.: US 2024/0284948 A1
(43) Pub. Date: Aug. 29, 2024

(54) HIGH EFFICIENCY FERMENTATION PROCESSES AND ASSOCIATED FOOD PRODUCTS PREPARED USING THE SAME

(71) Applicants: Xiong Wei, Kunshan (CN); Yu Fang, Kunshan (CN); Chen Yiqiang, Kunshan (CN)

(72) Inventors: Xiong Wei, Kunshan (CN); Yu Fang, Kunshan (CN); Chen Yiqiang, Kunshan (CN)

(21) Appl. No.: 18/115,368

(22) Filed: Feb. 28, 2023

(51) Int. Cl. A23L 19/00; A23B 7/005; A23B 7/015; A23B 7/026; A23L 5/20; B01D 71/02

(52) U.S. Cl. CPC A23L 19/01; A23B 7/005; A23B 7/015; A23B 7/026; A23L 5/20; B01D 71/02

(57) ABSTRACT

A high efficiency fermentation process/method for converting nitrate to nitrite in food products, comprising the steps of: (a) providing a food product, wherein the food product comprises a fermentable liquid medium obtained and/or derived from an edible nitrate containing plant; and (b) controllably fermenting the food product such that nitrate to nitrite conversion results in nitrite concentration levels greater than approximately 3% by weight.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO A SEQUENCE LISTING

Not applicable.

### BACKGROUND OF THE INVENTION

### 1. Field of the Invention

The present invention relates in general to conversion processes for food products and, more particularly, to high efficiency fermentation processes for converting nitrate to nitrite in food products, wherein remarkably high concentration levels of nitrite are obtained. Notably, the conversion processes of the present invention result in nitrite concentrations more than quadruple that of the competition and industry standards. In fact, the conversion processes of the present invention are so efficient relative to industry standards that products can be diluted with, for example, salt and still comply with industry specifications. Such efficiency offers increased flexibility in product formulations, as well as decreased net cost. For example, the conversion processes of the present invention provide for 90,000 ppm or 90K formulations, which are approximately three to four times that of others in the industry—with 22.5K and 30K formulations being most common.

### 2. Background Art

Methods for converting nitrate to nitrite in food products have been known in the art for years and are the subject of a plurality of patents and/or publications, including: Chinese Patent Number 110465368 entitled “A Kind of Processing Method of Celery Powder,” Chinese Patent Number 105767834 entitled “Preparation Method of Instant Celery Tablets,” Chinese Patent Number 105725090 entitled “Composite Celery Powder Pickling Agent,” Chinese Patent Number 104082699 entitled “Preparation Method of Fermented Celery Powder Based on Natural Preserving,” Chinese Patent Number 103960604 entitled “Pure Nature Low Temperature Baked Cooked Celery Powder and Production Method Thereof,” Chinese Patent Number 102524359 entitled “Celery Powder Nitrite and Industrial Preparation Method Thereof,” Chinese Patent Number 102224910 entitled “Method for Producing Food Ingredient Rich in Nitrite and Flavonoid by Use of Celery Leaves,” Chinese Patent Number 102166006 entitled “Method for Making Celery Powder,” Chinese Patent Number 1326471C entitled “Natural Celery Powder and Its Making Process,” and Chinese Patent Number CN1139342C entitled “Method for Preparing Concentrated Dry Celery Powder by Freeze Drying Technology”-all of which are hereby incorporated herein by reference in their entirety including all references cited therein.

Chinese Patent Number 110465368 appears to disclose methods for processing celery powder. The process equipment includes a main grinding machine, a secondary grinding machine, a first level inner circulating tube, a second level inner circulating tube, an outer circulating tube, a cyclone dust collector, a sack cleaner, a returning charge conveyer, and a gas treatment branch. The exit flow of the secondary grinding machine imports the centrifugal blower fan blade wheel rotation of the impact kinetic energy recycling main grinding machine of the impeller-driven in the feed pipe of the main grinding machine. The outlet of outer circulating tube connects with the entrance of main grinding machine. The import of the outer circulating tube is the air inlet. There are feed opening and returning charge entrances on the outer circulating tube. The air inlet of the cyclone dust collector connects with the secondary mill entrance. The cyclone dust collector exhaust outlet connects with the air inlet of the sack cleaner. The material undergoes high speed grinding and discharges moisture by the cyclone dust collector and the sack cleaner. The conveying drying/grinding machine is pneumatically driven, and the kinetic energy is recycled. The nutritional characteristics of the product remain intact.

Chinese Patent Number 105767834 appears to disclose a method of deep processing vegetables and a method of instantly preparing celery tablets. The preparation process includes the following four steps: celery treatment, celery liquid preparation, celery powder preparation and pure powder tablet production. First, celery is clean processed. Second, the clean celery is exposed to scalding hot water. Third, the celery is placed into a mixing beater where it becomes a celery slurry. Next, the celery slurry is filtered and then spray-dried into celery powder with a spray dryer. Finally, honey water is added into the celery powder while stirring the mixture. The stirred mixture is put into a tablet press machine to produce celery powder tablets, and the celery powder tablets are put into a drying baker to be dried, thereby obtaining the finished product of the instant celery tablets.

Chinese Patent Number 105725090 appears to disclose a composite celery powder pickling agent which is prepared from the following components: 100-200 mg/kg of pomegranate peel polyphenols, 0.2-0.4% of celery powder, 270-330 mg/kg of vitamin C, 360-440 mg/kg of tea polyphenol, 150-250 mg/kg of bamboo leaf flavonoid and 150-320 mg/kg of Salvia officinalis extract powder. The bamboo leaf flavonoid, tea polyphenol, user-made celery powder, user-made Salvia officinalis extract powder and pomegranate peel polyphenols are compounded to prepare the pickling agent. Then the residual amount of nitrite in the pickled meat product can be effectively reduced, and meanwhile the quality of the pickled meat product can be improved.

Chinese Patent Number 104082699 appears to disclose a method for naturally preparing fermented celery powder having the following steps, namely: (1) the celery powder is prepared; (2) strain addition, to be more specific, inoculating SACCO Lyocarni WBL-45 composite strain in amount of 2.36*107 CFU/g to obtain a mixed solution; (3) fermentation celery powder preparation, to be more specific, putting the mixed solution into a constant temperature oscillator for uniform-speed oscillation with the speed controlled in 150 r/min at 38° C., taking the mixed solution out every 30 min, using a sodium hydroxide solution to adjust the pH of the mixed solution to 7-7.1, putting the mixed solution back to the constant temperature oscillator to continue fermentation, after the fermentation is performed for 12 h, taking the mixed solution out, using a vacuum freezing dryer for 48 h of dehydration to obtain the fermented celery powder. The preparation method has the advantages of simple and easy operation, low production cost and controllable production quality, the prepared fermented celery powder is high in the nitrite content, and the preparation method is suitable for the requirement of industrial production.

Chinese Patent Number 103960604 appears to disclose a pure nature low temperature baked celery powder, and a production method thereof. The production method comprises: carrying out screening, root removing, washing, leaf removing, immersing and blanching, and dewatering on fresh celery, cutting the celery into leaves, small branches and celery stems, respectively adopting boiling salt water with a temperature of more than or equal to 95° C. to immerse and blanch until achieving a semi-transparent state, taking out, dewatering, cutting into slices, respectively carrying out 50-60° C. constant temperature vacuum baking processing on the dewatered celery leaves. The dewatered small branches and the cut celery slices are baked at low temperature to obtain sterilized, dried celery. The dried celery is grinded into celery powder with a particle fineness of more than or equal to 120 mesh through a crushing machine. According to the present invention, the cold drug-nature of the celery is neutralized, the original taste, the nutritional components and the good color of the celery are maintained, the powder presents the microscopic porous structure, has good rehydration, can be directly taken for a long time through infusion with boiling water, and can further be used as the preparation material of food, beverages and traditional Chinese medicine.

Chinese Patent Number 102524359 appears to disclose a celery powder nitrite and an industrial preparation method thereof. According to the industrial preparation method, the celery powder nitrite is a powdery substance prepared from celery by the steps of raw material treatment, blanching and de-enzyme processing, dehydrating and crushing, bio-nitrifying, drying and caking and secondary crushing, wherein the powdery substance has the bio-nitrite content of 0.5%-1.2%, the water content of 3%-5% and the powder fineness of 50-120 meshes. Nitrite in celery is converted into vegetal nitrite by adopting a biological conversion technology with the conversion rate up to 80-85%. The industrial preparation method is a green deep processing high-efficiency comprehensive utilization technology in the extended industrial chain of cress, and the celery powder nitrite is an ideal vegetal nitrite in the traditional food-grade nitrites and can be used as a natural ingredient of meat products.

Chinese Patent Number 102224910 appears to disclose a method for producing a food ingredient rich in nitrite and flavonoid by use of celery leaves, belonging to the field of vegetable deep-processing technology. According to the invention, the celery leaves are used as a raw material which is subjected to sorting and cleaning, decoloring, pulping, microbial conversion, drying and crushing. A food ingredient product celery powder is produced which contains 1.8% of nitrite, 3.5% of flavonoid and less than or equal to 5% of water. The food ingredient celery powder can be used for processing meat products, and has effects of protecting color, resisting oxidation and eliminating free radicals. If the celery powder prepared by the method disclosed by the invention accounts for 0.75%, the equivalent amount of nitrite and residual amount of nitrite in meat products both meet the requirements of GB2760-2007.

Chinese Patent Number 102166006 appears to disclose a method for making celery powder which comprises the steps of: screening fresh celeries as raw material, and then heating to inactivate enzymes; protecting the color in a zinc acetate solution and an ascorbic acid solution; drying; and finally crushing, screening, vacuum-packaging and sterilizing the treated celery to obtain a celery powder finished product. The product has a clear green color, rich nutrition and long shelf life.

Chinese Patent Number 1326471 appears to disclose a natural celery powder and a method for making the same. The present invention also relates to a natural celery powder preparation for keeping original color and high nutritive value of fresh celery and a preparing method thereof. The natural celery powder of the present invention solves the problems of poor color and poor solubility existing in the present celery processed products. The present invention has the technical scheme that a wet process is adopted; fresh celery used as main raw material is cleaned, cut, precooked for protecting color, pulped, milled into colloid, processed by secondary treatment, compounded, homogenized, sterilized, concentrated, dried, processed in a powder collection mode, screened, packaged and warehoused so as to obtain the powdery celery product. The whole process is completed in a mechanical continuous operation mode. The product of the present invention has the advantages of good taste, bright color, high solution speed and rich nutrient component. Original color, fragrance, and taste of the fresh celery are preserved.

Chinese Patent Number CN1139342C appears to disclose a method for preparing concentrated celery powder through a freeze-drying technique. The present invention is characterized in that: (a) celery is extracted into juice and is filtered, (b) the filtered celery juice is put in a vacuum freeze drier (−5° C. to 25° C.), and (c) the temperature is raised to 20° C. to 35° C. for 28 to 48 hours while, at the same time, vacuum drying, so a dried solid of which the water content does not exceed 5 to 15% is obtained.

While the above-identified patents and publications do appear to disclose various methods for making celery powder, their methods remain non-desirous and/or problematic inasmuch as, among other things, none of the above-identified references appear to disclose high efficiency fermentation processes for converting nitrate to nitrite in food products.

These and other objects of the present invention will become apparent in light of the present specification, claims, and drawings.

### SUMMARY OF THE INVENTION

The following presents a simplified summary in order to provide a basic understanding of some aspects of the claimed subject matter. This summary is not an extensive overview, and is not intended to identify key/critical elements or to delineate the scope of the claimed subject matter. Its purpose is to present some concepts in a simplified form as a prelude to the more detailed description that is presented later.

The present invention is directed to a high efficiency fermentation method for converting nitrate to nitrite in food products, comprising the steps of, consisting essentially of and/or consisting of the steps of: (a) providing a food product, wherein the food product comprises a fermentable liquid medium obtained and/or derived from an edible nitrate containing plant; and (b) controllably fermenting the food product such that nitrate to nitrite conversion results in nitrite concentration levels greater than approximately (+/−0.25%) 3% by weight.

In a preferred embodiment of the present invention, the step of providing a food product includes the step of providing a fermentation liquid obtained and/or derived from at least one of spinach, mustard greens, arugula, kale, swiss chard, lettuce, beetroot, beets, radishes, turnips, watercress, bok choy, Chinese cabbage, kohlrabi, chicory leaf, celery, carrots, onion, and garlic.

In another preferred embodiment of the present invention, the step of providing a food product includes the step of providing a fermentation liquid obtained and/or derived from celery.

In yet another preferred embodiment of the present invention, the step of providing a food product includes the step of providing a fermentation liquid obtained and/or derived from beets.

In one preferred embodiment of the present invention, the step of controllably fermenting the food product results in nitrite concentration levels greater than approximately (+/−0.25%) 5% by weight.

In a preferred implementation of the present invention, the step of controllably fermenting the food product results in nitrite concentration levels greater than approximately (+/−0.25%) 7% by weight.

In another preferred implementation of the present invention, the step of controllably fermenting the food product results in nitrite concentration levels greater than approximately (+/−0.25%) 9% by weight.

In yet another preferred implementation of the present invention, the step of controllably fermenting the food product results in nitrite concentration levels greater than approximately (+/−0.25%) 10% by weight.

In a preferred embodiment of the present invention, the method further comprises the step of passing the food product through a first filter. In this embodiment, the step of passing the food product though a first filter preferably includes the step of passing the food product through a ceramic membrane to separate bacteria and solids, and produce a dark brown clear solution.

In another preferred embodiment of the present invention, the method further comprises the step of passing the food product through a second filter. In this embodiment, the step of passing the food product though a second filter preferably includes the step of direct filtration after the end of fermentation with live bacteria, with the process control temperature not exceeding 50° C., and when the proportion of filtrate volume reaches about 90%, initiating cleaning and washing with clear water, wherein the flow acceleration and filtration speed are approximately the same, and wherein the filtration is complete when the filtrate volume and stock liquid volume are equal. Alternatively, the step of passing the food product though a second filter preferably includes the step of direct filtration after the end of fermentation with live bacteria, with the process control temperature not exceeding 35° C., and the membrane pressure being approximately 10 MPa, and when the filtrate volume reaches 90% of the stock solution, the filtrate is washed with clear water until the volume of the transmitted liquid is equal to the volume of the stock solution.

In yet another preferred embodiment of the present invention, the method further comprises the step of controllably exposing the food product to ultra-high-temperature and/or electromagnetic radiation processing for a period of time, and at least one of pasteurizing, sanitizing, and sterilizing the food product.

In one preferred embodiment of the present invention, the method further comprises the step of controllably spray drying the food product at high-temperature.

The present invention is also directed to a food product prepared according to one or more of the methods disclosed herein.

### BRIEF DESCRIPTION OF THE DRAWINGS

Certain embodiments of the present invention are illustrated by the accompanying figures. It will be understood that the figures are not necessarily to scale and that details not necessary for an understanding of the invention or that render other details difficult to perceive may be omitted.

It will be further understood that the invention is not necessarily limited to the particular embodiments illustrated herein.

The invention will now be described with reference to the drawings wherein:

FIG. 1 of the drawings is a schematic representation of a method for preparing a food product according to the present invention, and FIGS. 2-5 of the drawings are two-dimensional graphs associated with results from Examples 1-11.

### DETAILED DESCRIPTION OF THE INVENTION

While this invention is susceptible of embodiment in many different forms and applications, there are shown in the drawings and described herein in detail several specific embodiments with the understanding that the present disclosure is to be considered as an exemplification of the principles of the invention and is not intended to limit the invention to the embodiments illustrated.

It will be understood that like or analogous elements and/or components, referred to herein, may be identified throughout the drawings by like reference characters. In addition, it will be understood that the drawings are merely schematic representations of one or more embodiments of the invention, and some of the components may have been distorted from their actual scale for purposes of pictorial clarity.

The high efficiency fermentation processes/methods of the present invention provide for the conversion of nitrate to nitrite in food products, wherein remarkably high concentration levels of nitrite are obtained. For example, the conversion processes of the present invention provide for 90,000 ppm or 90K formulations, which are approximately three to four times that of others in the industry.

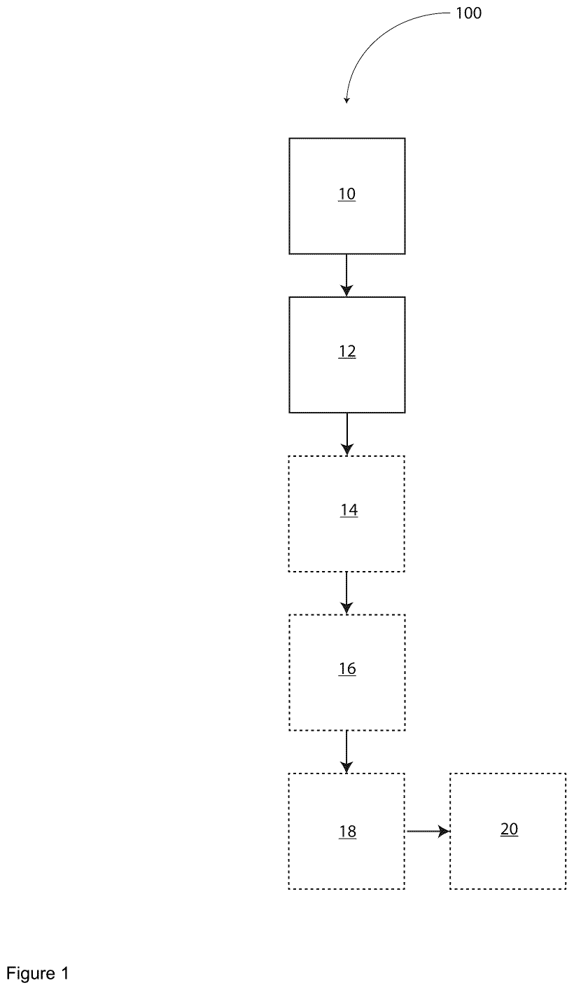

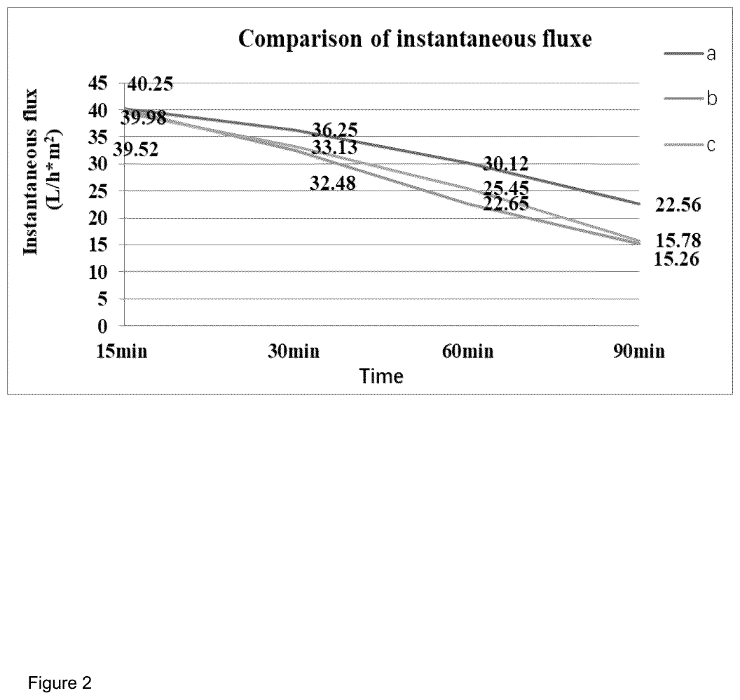

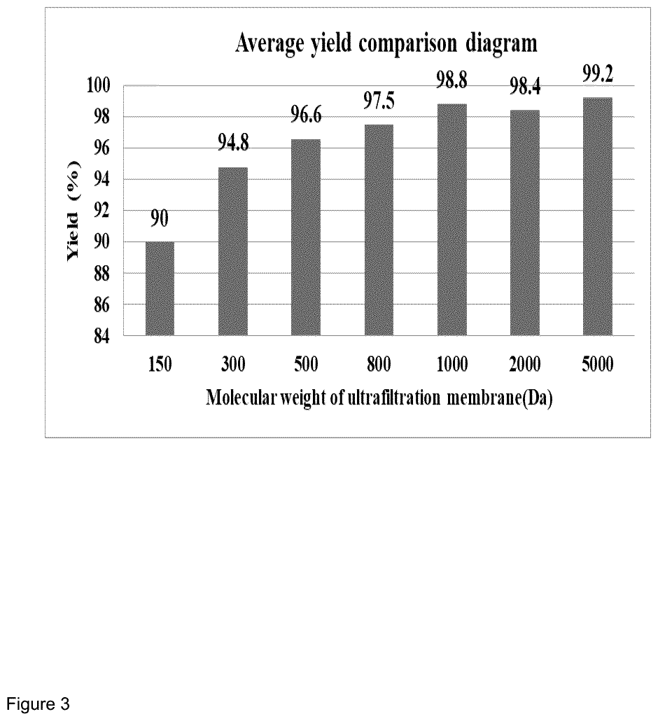

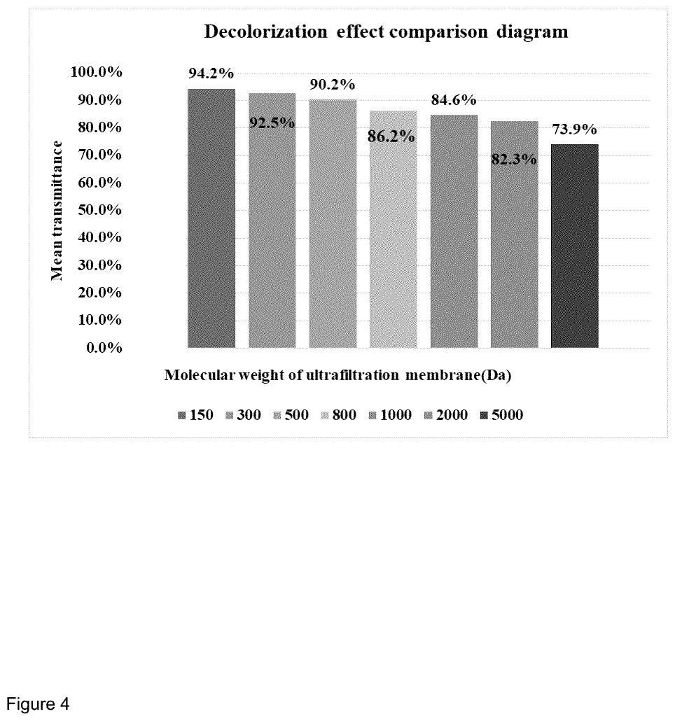

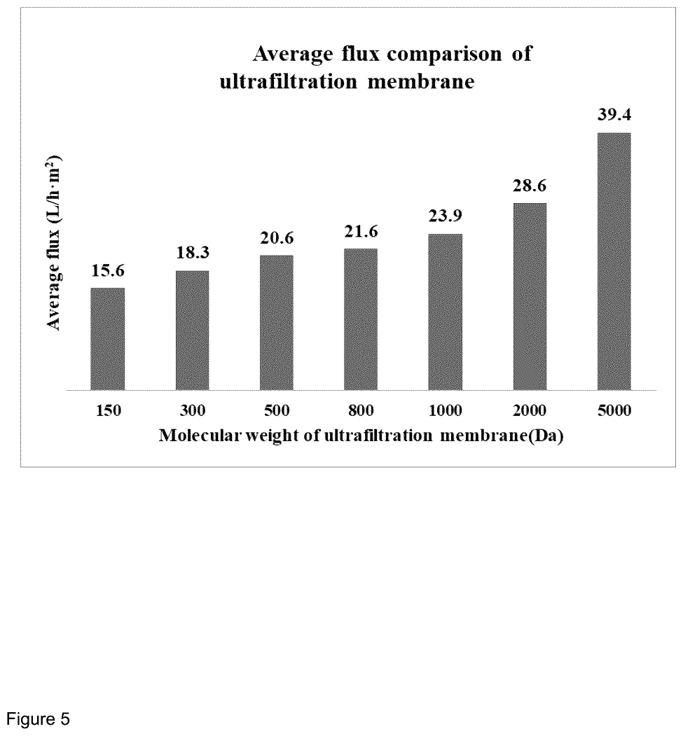

Referring now to the drawings, and to FIG. 1 in particular, a first embodiment of method 100 is shown as generally comprising the steps of: (10) providing a food product, wherein the food product comprises a fermentable liquid medium obtained and/or derived from an edible nitrate containing plant; and (12) controllably fermenting the food product such that nitrate to nitrite conversion results in nitrite concentration levels greater than approximately (+/−0.25%) 3% by weight, and more preferably greater than approximately (+/−0.25%) 5%, 7%, 9%, and 10% by weight. Additional details regarding the fermentation methods are provided in the Examples herein below. Additional optional steps of the present invention include the steps of: (14) passing the food product through a first filter; (16) passing the food product through a second filter (either before, after, and/or simultaneously with the first filter); (18) controllably exposing the food product to ultra-high-temperature processing and/or electromagnetic radiation for a period of time, and at least one of pasteurizing, sanitizing, and sterilizing the food product; and (20) controllably spray drying the food product at high-temperature. Method steps 10-20 may be carried out simultaneously and/or in any sequential order of operation.

Preferably, the food product of the present invention comprise a fermentation liquid obtained and/or derived from at least one of spinach, mustard greens, arugula, kale, swiss chard, lettuce, beetroot, beets, radishes, turnips, watercress, bok choy, Chinese cabbage, kohlrabi, chicory leaf, celery, carrots, onion, and garlic. In one embodiment, the food products of the present invention preferably comprise celery fermentation liquid including celery, yeast powder (0.3-0.7%), peptone (0.1-0.5%), sodium chloride (0.1-0.3%), and water (Q.S. 100%), and the fermentation medium of the present invention preferably comprise celery juice (25-40%), yeast powder (0.5-5.0%), peptone (0.1-0.5%), sodium chloride (0.1-1.0%), disodium hydrogen phosphate dodecahydrate (0.1-0.5%), and water (Q.S. 100%).

In accordance with the present invention, step 14 of method 100 includes passing the food product through a first filter. This product is typically a fermentation liquid, and the first filter is preferably a cross-flow ceramic membrane that removes particles greater than approximately 2 microns, and more preferably greater than approximately 0.50 microns, and yet more preferably greater than approximately 0.005 microns. In this embodiment, the ceramic membrane preferably separates bacteria and solids, and produces or yields a dark brown clear solution which is subsequently filtered and then preferably spray dried. The first filter is preferably commercially available from Jiangsu Jiuwu High-tech Co., LTD, China. Non-limiting examples include models: CMF19040-OD30 1,200 nm length, serial number: 92020, raw material: α-Alumina/Zirconia, pore size: 20 nm, 50 nm, 200, nm, construction: multi-channel 19, tubular element, pure water flux: 600-700 l/m2·h·bar, element water flux: 174-203 LPH, test conditions: 14 psi (1 bar), 86° F. (25° C.) with pure water. The ceramic membrane elements of the present invention preferably include an asymmetrical structure consisting of three layers, namely: a filtering layer, an intermediate layer, and a support layer. The pressure drop of such asymmetrical structure is lower than that of the symmetrical structure of membranes, which means that the ceramic membrane element has a better recovery. The ceramic membrane elements of the present invention also preferably adopt dynamic cross-flow filtration which achieves stable fluxes and which are superior to traditional dead-end and/or filter-cake filtration. The ceramic membrane elements of the present invention preferably include elements with pore sizes ranging from approximately (+/−5%) 2 nm to approximately 1,200 (+/−5%) nm.

After the food product is filtered via the ceramic membrane, the food product preferably undergoes a secondary filtration. This filter assembly is commercially available from Shihan (Tianjin) Energy Saving and Environmental Protection Technology Co., LTD., China. In accordance with the present invention, step 16 of method 100 comprises the step of passing the food product through a second filter which includes the step of direct filtration after the end of fermentation with live bacteria, with the process control temperature not exceeding 50° C., and when the proportion of filtrate volume reaches about 90%, initiating cleaning and washing with clear water, wherein the flow acceleration and filtration speed are approximately the same, and wherein the filtration is complete when the filtrate volume and stock liquid volume are equal.

In another embodiment, the step of passing the food product though a second filter includes the step of direct filtration after the end of fermentation with live bacteria, with the process control temperature not exceeding 35° C., and the membrane pressure being approximately 10 MPa, and when the filtrate volume reaches 90% of the stock solution, the filtrate is washed with clear water until the volume of the transmitted liquid is equal to the volume of the stock solution.

After filtration as disclosed herein, the filtered food product is clear and free from visible particulates as perceived by the human eye unmagnified.

Notably, the filtered food product results in an injected meat or other food product having an increased a* value relative to the same food product without the injection. Preferably, the a* value is increased by approximately (+/−2%) 10%, more preferably the a* value is increased by approximately (+/−2%) 25%, and yet more preferably the a* value is increased by approximately (+/−2%) 50%.

In accordance with the present invention, optional step 18 of method 100 includes controllably exposing the food product to ultra-high-temperature processing which includes the step of exposing the food product to flash heating via a direct heating system (e.g., an injection-based system, an infusion-based system, etcetera) and/or an indirect heating system (e.g., plate exchangers, tubular exchangers, scraped-surface exchangers, etcetera). These systems are commercially available from, for example, Tetra Pak (Pully, Switzerland). These systems provide for controllably exposing the food product to ultra-high-temperature processing for a period of time such as heating the food product to at least approximately 135 degrees Centigrade for between approximately (+/−10%) one and approximately (+/−10%) ten seconds, and more preferably to at least approximately (+/−10%) 148 degrees Centigrade for between approximately (+/−10%) one and approximately (+/−10%) three seconds.

The methods of the present invention, also include the step of controllably exposing the food product to an electromagnetic radiation source. Preferably, the electromagnetic radiation source which is substantially mercury free and/or substantially free from generating ozone during operation of the same. Suitable examples of electromagnetic radiation sources include, but are not limited to, those commercially available from Pro Mach (Cincinnati, Ohio). In one embodiment, the electromagnetic radiation source comprises pulsed UV-B electromagnetic radiation. In this embodiment, the food product is exposed to electromagnetic radiation having a pulse duration of less than approximately (+/−10%) 10 milliseconds, and more preferably less than approximately (+/−10%) 5 milliseconds, and yet more preferably less than approximately (+/−10%) 2 milliseconds. Moreover, the food product is preferably exposed to electromagnetic radiation for a total duration of less than approximately (+/−10%) 30 seconds, and more preferably less than approximately (+/−10%) 5 seconds, and yet more preferably lees than approximately (+/−10%) 2 seconds.

In one aspect of the present invention, the step of controllably exposing the food product to electromagnetic radiation for a period of time preferably comprises controllably exposing the food product to pulsed electromagnetic radiation having a percent transmission of less than approximately 80% at below approximately 240 nanometers.

In another aspect of the present invention, the ultra-high-temperature flash exposure and/or the electromagnetic radiation source pasteurizes, sanitizes, and/or sterilizes the food product by providing a greater than approximately (+/−1 Log) 8 Log reduction in undesirable matter in less than approximately (+/−10%) 1 to approximately (+/−10%) 10 seconds.

In accordance with the present invention, method 100 includes step 20 for controllably spray drying the food product. In one embodiment, the step of controllably spray drying the food product at high-temperature includes the step of spray drying via a centrifugal spray dryer. In this embodiment, the step of controllably spray drying the food product at high-temperature preferably includes maintaining an air inlet temperature from between approximately 220 to approximately 240 degrees Centigrade, maintaining an air outlet temperature from between approximately 100 to approximately 140 degrees Centigrade, maintaining an atomization frequency from between approximately 3,500 r/m to approximately 3,700 r/m at ambient pressure. In another embodiment of the present invention, the step of controllably spray drying the food product at high-temperature includes the step of spray drying via a pressure spray dryer. In this embodiment, the step of controllably spray drying the food product at high-temperature preferably includes maintaining an air inlet temperature from between approximately 180 to approximately 220 degrees Centigrade, maintaining an air outlet temperature from between approximately 100 to approximately 120 degrees Centigrade, maintaining an atomization pressure from between approximately 100 MPa to approximately 120 MPa.

Step 20 preferably results in a food product having a Karl Fischer moisture content of less than approximately 2% without materially altering the flavor profile and/or the nutritional profile of the food product.

Step 20 may also comprise the step of associating a filler with the food product simultaneously with and/or prior to the step of controllably spray drying. Non-limiting examples of filler material include sea salt, Himalayan salt, Kosher salt, potassium chloride, and sodium chloride. Preferably, the concentration of the filler ranges from approximately (+/−5%) 15% to approximately (+/−5%) 40%.

Step 20 may also include the step of associating an anticoagulant with the food product simultaneously with and/or prior to the step of controllably spray drying. In one embodiment, the anticoagulant preferably comprises silicon dioxide present in a concentration between 0.025% and 5%. In another embodiment, the anticoagulant comprises an alkyl dimethicone cross-polymer present in a concentration between 0.025% and 5%, such as those disclosed in United States Patent Application Publication Number 2013/0115331 A1 entitled “Alkyl Dimethicone Cross-polymer Additive to Chewing Gum and Chewing Gum Having Alkyl Dimethicone Cross-polymer—which is hereby incorporated herein by reference in its entirety including all references cited therein.

The invention is further described by additional examples and experiments hereinbelow.

### Example I

Seed medium (%): Yeast Powder 0.5%; Peptone 0.3%; Sodium chloride 0.2%; fill with distilled water to 100%. Fermentation medium (%): Celery juice 30%, Yeast Powder 1.0%; Peptone 0.5%; Sodium chloride 0.5%; Disodium hydrogen phosphate dodecahydrate 0.05%; fill with clear water to 100%. After thawing, the prepared glycerol tube bacteria suspension was transferred to 500 mL triangular flask containing 100 mL seed medium, and incubated for about 15 h at 37° C. and 150 r/min on a shaker. The incubated seed solution was inoculated 0.5% into a 100 L seed tank containing 70 L seed medium and incubated with stirring. The cultured seed solution was inserted into a 700 L mechanical stirring fermenter with an inoculum volume of 10%, and the initial pH was 7.0. The inoculum was divided into two stages: in the first stage, the cultured seed solution was transferred into fermentation medium for culture, and the pH was controlled to facilitate the proliferation of bacteria. In the second stage, when the fermentation culture is in the fifth hour, the seed liquid has been cultured for the second time, and the pH is continued to be controlled. The automatic flow of liquid alkali is added to maintain the pH at about 7.0, so as to facilitate the growth of bacteria and the transformation of products. During fermentation, the temperature was controlled at 37° C. After fermentation, the highest conversion rate of target product was 85%.

### Example II

Seed medium (%): Yeast Powder 0.5%; Peptone 0.3%; Sodium chloride 0.2%; fill with clear water to 100%. Fermentation medium (%): Celery juice 30%, Yeast Powder 1.0%; Peptone 0.5%; Sodium chloride 0.5%; Disodium hydrogen phosphate dodecahydrate 0.05%; fill with clear water to 100%. After thawing, the prepared glycerol tube bacteria suspension was transferred to 500 mL triangular flask containing 100 mL seed medium, and incubated for about 15 h at 37° C. and 150 r/min on a shaker. The incubated seed solution was inoculated 0.5% into a 100 L seed tank containing 70 L seed medium and incubated with stirring. The cultivated seed liquid was connected to the 700 L mechanical stirring fermenter with an inoculum volume of 10%, and the initial pH was 7.0. By means of one inoculation, the cultivated seed liquid was transferred to the fermentation medium for culture, and the pH was controlled to facilitate the proliferation of bacteria. The automatic flow of liquid alkali is added to maintain the pH at about 7.0, so as to facilitate the growth of bacteria and the transformation of products. During fermentation, the temperature was controlled at 37° C. After fermentation, the highest conversion rate of target product was 73.02%, which was 14.09% lower than that of existing process.

### Example III

Seed medium (%): Yeast Powder 0.5%; Peptone 0.3%; Sodium chloride 0.2%; fill with clear water to 100%. Fermentation medium (%): Celery juice 30%, Yeast Powder 1.0%; Peptone 0.5%; Sodium chloride 0.5%; Disodium hydrogen phosphate dodecahydrate 0.05%; fill with clear water to 100%. After thawing, the prepared glycerol tube bacteria suspension was transferred to 500 mL triangular flask containing 100 mL seed medium, and incubated for about 15 h at 37° C. and 150 r/min on a shaker. The incubated seed solution was inoculated 0.5% into a 100 L seed tank containing 70 L seed medium and incubated with stirring. The cultivated seed liquid was connected to the 700 L mechanical stirring fermenter with an inoculum volume of 10%, and the initial pH was 7.0. By means of one inoculation, the cultivated seed liquid was transferred to the fermentation medium for culture, and the pH was controlled to facilitate the proliferation of bacteria. The automatic flow of liquid alkali is added to maintain the pH at about 7.0, so as to facilitate the growth of bacteria and the transformation of products. During fermentation, the temperature was controlled at 37° C., and when the sugar content in the medium decreased to 50 g/L, the product transformation conditions were entered by adjusting the ventilation volume and stirring. After fermentation, the highest conversion rate of target product was 94%, which was 10.58% higher than that of original process.

### Example IV

Seed medium (%): Yeast Powder 0.5%; Peptone 0.3%; Sodium chloride 0.2%; fill with clear water to 100%. Fermentation medium (%): Celery juice 30%, Yeast Powder 1.0%; Peptone 0.5%; Sodium chloride 0.5%; Disodium hydrogen phosphate dodecahydrate 0.05%; fill with clear water to 100%. After thawing, the prepared glycerol tube bacteria suspension was transferred to 500 mL triangular flask containing 100 mL seed medium, and incubated for about 15 h at 37° C. and 150 r/min on a shaker. The incubated seed solution was inoculated 0.5% into a 100 L seed tank containing 70 L seed medium and incubated with stirring. The cultivated seed liquid was connected to the 700 L mechanical stirring fermenter with an inoculum volume of 10%, and the initial pH was 7.0. By means of one inoculation, the cultivated seed liquid was transferred to the fermentation medium for culture, and the pH was controlled to facilitate the proliferation of bacteria. The automatic flow of liquid alkali is added to maintain the pH at about 7.0, so as to facilitate the growth of bacteria and the transformation of products. During fermentation, the temperature was controlled at 37° C., and when the sugar content in the medium decreased to 30 g/L, the product transformation conditions were entered by adjusting the ventilation volume and stirring. After fermentation, the highest conversion rate of target product was 92%, which was 8.23% higher than that of original process.

### Example V

Seed medium (%): Yeast Powder 0.5%; Peptone 0.3%; Sodium chloride 0.2%; fill with clear water to 100%. Fermentation medium (%): Celery juice 30%, Yeast Powder 1.0%; Peptone 0.5%; Sodium chloride 0.5%; Disodium hydrogen phosphate dodecahydrate 0.05%; fill with clear water to 100%. After thawing, the prepared glycerol tube bacteria suspension was transferred to 500 mL triangular flask containing 100 mL seed medium, and incubated for about 15 h at 37° C. and 150 r/min on a shaker. The incubated seed solution was inoculated 0.5% into a 100 L seed tank containing 70 L seed medium and incubated with stirring. The cultivated seed liquid was connected to the 700 L mechanical stirring fermenter with an inoculum volume of 10%, and the initial pH was 7.0. By means of one inoculation, the cultivated seed liquid was transferred to the fermentation medium for culture, and the pH was controlled to facilitate the proliferation of bacteria. The automatic flow of liquid alkali is added to maintain the pH at about 7.0, so as to facilitate the growth of bacteria and the transformation of products. During fermentation, the temperature was controlled at 37° C., and when the sugar content in the medium decreased to 40 g/L, the product transformation conditions were entered by adjusting the ventilation volume and stirring. After fermentation, the highest conversion rate of target product was 98%, which was 15.29% higher than that of original process.

### Example VI

Seed medium (%): Yeast Powder 0.5%; Peptone 0.3%; Sodium chloride 0.2%; fill with distilled water to 100%. Fermentation medium (%): Celery juice 30%, Yeast Powder 1.0%; Peptone 0.5%; Sodium chloride 0.5%; Disodium hydrogen phosphate dodecahydrate 0.05%; fill with clear water to 100%. After thawing, the prepared glycerol tube bacteria suspension was transferred to 500 mL triangular flask containing 100 mL seed medium, and incubated for about 15 h at 37° C. and 150 r/min on a shaker. The incubated seed solution was inoculated 0.5% into a 100 L seed tank containing 70 L seed medium and incubated with stirring. The cultured seed solution was inserted into a 700 L mechanical stirring fermenter with an inoculum volume of 10%, and the initial pH was 7.0. The inoculum was divided into two stages: in the first stage, the cultured seed solution was transferred into fermentation medium for culture, and the pH was controlled to facilitate the proliferation of bacteria. In the second stage, when the fermentation culture is in the fifth hour, the seed liquid has been cultured for the second time, and the pH is continued to be controlled. The automatic flow of liquid alkali is added to maintain the pH at about 7.0, so as to facilitate the growth of bacteria and the transformation of products. During fermentation, the temperature was controlled at 37° C., and when the sugar content in the medium decreased to 40 g/L, the product transformation conditions were entered by adjusting the ventilation volume and stirring. After fermentation, the highest conversion rate of target product was 93.2%, which was 9.65% higher than that of original process.

### Example VII

In this embodiment, according to the above fermentation method, the separation method of celery fermentation liquid with bacteria liquid is described:

(a) Take 500 L of celery juice fermentation broth, its nitrite content is 10866 ppm, filter the fermentation broth with ceramic membrane, the membrane core aperture is 50 nm, the membrane area is 3 m², control the operating temperature is about 40° C., concentrate 10 times by volume, wash the bacteria twice by volume, collect a total of 500 L filtrate, its nitrite content is 10648 ppm, accounting for 98%.

(b) Take 500 L of celery juice fermentation broth, its nitrite content is 10765 ppm. The fermentation broth adopts the plate and frame filtration method, the filtration area is 3 m², after ending, with 50 L clean water circulation for 10 min, press dry, collect filtrate a total of 520 L, its nitrite content is 10268 ppm, accounting for 99.3%.

(c) Take 500 L of celery juice fermentation broth, its nitrite content is 11245 ppm, and use three-foot centrifuge to separate the bacteria liquid at a speed of 35000 r/min. After the material is fed, wash with 50 L of clean water, and collect 505 L of filtrate, its nitrite content is 10521 ppm, accounting for 94.6%. After testing, the three kinds of equipment can effectively separate the bacteria from the solid, and the yield of the centrifugation method is slightly lower.

### Example VIII

The influence of the three filtrates of example 7 on the decolorization and purification process of ultrafiltration membrane was tested. The ultrafiltration membrane equipment was the pilot-scale equipment provided by Jiuanyuan. The ultrafiltration membrane was coil membrane with 2000 molecular weight, the membrane size was 2540, and the membrane area was 0.25 m².

(a) Take 100 L of ceramic membrane filtrate in Example 7 to pass ultrafiltration membrane with 1.5 MPa inlet pressure, controlling the temperature below 35° C. The nitrite content of ceramic membrane filtrate is 10284 ppm with 25.6% light transmission. The ceramic membrane filtrate is concentrated 10 times by volume, and washed twice by volume of the concentrated liquid with clean water. A total of 100 L of the liquid was transmitted, the nitrite content was measured to be 10078 ppm, the transmittance was 86.5% at 550 nm, the yield was 98%, and the operation of the equipment was recorded (FIG. 2).

(b) Take 100 L of plate and frame filtrate in Example 7 to pass ultrafiltration membrane with 1.5 MPa inlet pressure, controlling the temperature below 35° C. The nitrite content of ceramic membrane filtrate is 10356 ppm with 24.9% light transmission. The plate and frame filtrate is concentrated 10 times by volume, and washed twice by volume of the concentrated liquid with clean water. A total of 100 L of the liquid was transmitted, the nitrite content was measured to be 10078 ppm, the transmittance was 86.2% at 550 nm, the yield was 97.8%, and the operation of the equipment was recorded (FIG. 2).

(c) Take 100 L of centrifuged clear liquid in Example 7 to pass ultrafiltration membrane with 1.5 MPa inlet pressure, controlling the temperature below 35° C. The nitrite content of ceramic membrane filtrate is 10284 ppm with 25.2% light transmission. The ceramic membrane filtrate is concentrated 10 times by volume, and washed twice by volume of the concentrated liquid with clean water. A total of 100 L of the liquid was transmitted, the nitrite content was measured to be 10109 ppm, the transmittance was 86.5% at 550 nm, the yield was 98.3%, and the operation of the equipment was recorded (FIG. 2). After ultrafiltration membrane decolorization and purification treatment of three kinds of filtrate, the transmittance and yield are similar, but the overall flux of ceramic membrane filtrate in the decolorization process is significantly better than that of plate and frame filtrate and centrifugal filtrate. In conclusion, ceramic membrane filtration is preferred as the optimal filtration method for bacterial liquid separation.

### Example IX

In this embodiment, the selection of ultrafiltration membrane molecular weight in the decolorization and purification link will be described. The ultrafiltration membrane equipment adopts Hangzhou Ruina experimental ultrafiltration membrane equipment, and the membrane specification is model 1812. The main purpose is to make a comprehensive comparison of decolorization and impurity removal effect and filtration speed. Membrane molecular weights were selected as 150, 300, 800, 1000, 2000, 5000 Da.

(a) Take 10 L of ceramic membrane filtrate with 10842 ppm nitrite and 25.6% light transmission to pass ultrafiltration membrane with molecular weight of 150 Da. The inlet pressure is set as 1.5 MPa and controlling the temperature below 35° C. The ceramic membrane filtrate is concentrated 10 times by volume, and washed twice by volume of the concentrated liquid with clean water. A total of 10 L of the liquid was transmitted, the nitrite content was measured to be 9757 ppm, the transmittance was 94.2% at 550 nm, the yield was 90%, and the average flux was 15.6 L/h·m².

(b) Take 10 L of ceramic membrane filtrate with 10842 ppm nitrite and 24.6% light transmission to pass ultrafiltration membrane with molecular weight of 300 Da. The inlet pressure is set as 1.5 MPa and controlling the temperature below 35° C. The ceramic membrane filtrate is concentrated 10 times by volume, and washed twice by volume of the concentrated liquid with clean water. A total of 10 L of the liquid was transmitted, the nitrite content was measured to be 10083 ppm, the transmittance was 92.5% at 550 nm, the yield was 94.8%, and the average flux was 18.3 L/h·m².

(c) Take 10 L of ceramic membrane filtrate with 10842 ppm nitrite and 24.6% light transmission to pass ultrafiltration membrane with molecular weight of 500 Da. The inlet pressure is set as 1.5 MPa and controlling the temperature below 35° C. The ceramic membrane filtrate is concentrated 10 times by volume, and washed twice by volume of the concentrated liquid with clean water. A total of 10 L of the liquid was transmitted, the nitrite content was measured to be 10473 ppm, the transmittance was 90.2% at 550 nm, the yield was 96.6%, and the average flux was 20.6 L/h·m².

(d) Take 10 L of ceramic membrane filtrate with 10842 ppm nitrite and 24.6% light transmission to pass ultrafiltration membrane with molecular weight of 800 Da. The inlet pressure is set as 1.5 MPa and controlling the temperature below 35° C. The ceramic membrane filtrate is concentrated 10 times by volume, and washed twice by volume of the concentrated liquid with clean water. A total of 10 L of the liquid was transmitted, the nitrite content was measured to be 10570 ppm, the transmittance was 86.2% at 550 nm, the yield was 97.5%, and the average flux was 21.6 L/h·m².

(e) Take 10 L of ceramic membrane filtrate with 10842 ppm nitrite and 24.6% light transmission to pass ultrafiltration membrane with molecular weight of 1000 Da. The inlet pressure is set as 1.5 MPa and controlling the temperature below 35° C. The ceramic membrane filtrate is concentrated 10 times by volume, and washed twice by volume of the concentrated liquid with clean water. A total of 10 L of the liquid was transmitted, the nitrite content was measured to be 10711 ppm, the transmittance was 84.6% at 550 nm, the yield was 98.8%, and the average flux was 23.9 L/h·m².

(f) Take 10 L of ceramic membrane filtrate with 10842 ppm nitrite and 24.6% light transmission to pass ultrafiltration membrane with molecular weight of 2000 Da. The inlet pressure is set as 1.5 MPa and controlling the temperature below 35° C. The ceramic membrane filtrate is concentrated 10 times by volume, and washed twice by volume of the concentrated liquid with clean water. A total of 10 L of the liquid was transmitted, the nitrite content was measured to be 10688 ppm, the transmittance was 82.3% at 550 nm, the yield was 98.4%, and the average flux was 28.6 L/h·m².

(g) Take 10 L of ceramic membrane filtrate with 10842 ppm nitrite and 24.6% light transmission to pass ultrafiltration membrane with molecular weight of 5000 Da. The inlet pressure is set as 1.5 MPa and controlling the temperature below 35° C. The ceramic membrane filtrate is concentrated 10 times by volume, and washed twice by volume of the concentrated liquid with clean water. A total of 10 L of the liquid was transmitted, the nitrite content was measured to be 10755 ppm, the transmittance was 73.9% at 550 nm, the yield was 99.2%, and the average flux was 39.4 L/h·m². The test results are shown in FIGS. 3 to 5, it can be concluded that the selected films with different molecular weights can achieve certain decolorization and purification effects. Considering the treatment cycle, yield and decolorization effect, the films with molecular weights in the range of 1,000-2,000 are preferred.

### Example X

This embodiment describes the drying process of celery powder.

(a) Use centrifugal spray drying equipment to dry the configured materials as required. The inlet and outlet air temperature is 220° C.-240° C. and 100° C.-140° C., respectively. The atomization frequency is set as 3500 r/m to obtain fermented celery powder with 2% moisture. The weight yield of centrifugal spray drying is 95% and the content yield is 100%.

(b) Use pressure equipment to dry the configured materials as required. The inlet and outlet air temperature is 180° C.-220° C. and 100° C.-120° C., respectively. The atomization pressure is set as 100 MPa to obtain fermented celery powder with 2.5% moisture. The weight yield of pressure drying is 98% and the content yield is 100%.

### Example XI

According to the above extracted implementation cases, the optimal explanation is adopted. Fermented celery juice liquid was concentrated 10 times by ceramic membrane. The concentrated was washed twice by volume with clean water. The ceramic membrane permeating liquid was decolorized and purified with ultrafiltration membrane of 2000 Da to be concentrated 10 times by volume, and washed with clean water by 1 volume of concentrated liquid. Add auxiliary materials into ultrafiltration permeating liquid and stir evenly. The configured materials were sprayed dry with pressure spray drying equipment to get fermented celery powder, whose nitrite content is 1000 ppm-100000 ppm. The average extraction yield was 90%.

$$Extraction yield : Y = \frac{m \times w}{V \times c} \times 100 \%$$

Y: Extraction yield, %;
m: Quality of fermented celery powder, g;
w: Nitrite content in fermented celery powder, w/w;
V: Volume of fermentation broth, L;
c: Nitrite content in fermentation broth, g/L.

The foregoing description merely explains and illustrates the invention and the invention is not limited thereto except insofar as the appended claims are so limited, as those skilled in the art who have the disclosure before them will be able to make modifications without departing from the scope of the invention. Other preferred implementations of the present invention are disclosed in U.S. patent application Ser. No. 17/988,970 entitled “METHOD FOR PASTEURIZING/SANITIZING/STERILIZING FOOD PRODUCTS VIA ULTRA-HIGH TEMPERATURE PROCESSING AND OPTIONAL EXPOSURE TO AN ELECTROMAGNETIC RADIATION SOURCE,” U.S. patent application Ser. No. 18/115,322 entitled “FILTRATION METHODS AND ASSOCIATED FOOD PRODUCTS PREPARED USING THE SAME,” and U.S. patent application Ser. No. 18/078,282 entitled “SPRAY DRYING METHODS AND ASSOCIATED FOOD PRODUCTS PREPARED USING THE SAME”-all of which are hereby incorporated herein by reference in their entirety including all references cited therein.

While certain embodiments have been illustrated and described, it should be understood that changes and modifications can be made therein in accordance with ordinary skill in the art without departing from the technology in its broader aspects as defined in the following claims.

The embodiments, illustratively described herein may suitably be practiced in the absence of any element or elements, limitation or limitations, not specifically disclosed herein. Thus, for example, the terms “comprising,” “including,” “containing,” etcetera shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

The present disclosure is not to be limited in terms of the particular embodiments described in this application. Many modifications and variations can be made without departing from its spirit and scope, as will be apparent to those skilled in the art. Functionally equivalent methods and compositions within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions or biological systems, which can of course vary. It is also to be understood that the terminology used herein is for the purpose of describing particular embodiments only, and is not intended to be limiting.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etcetera. As a non-limiting example, each range discussed herein can be readily broken down into a lower third, middle third and upper third, etcetera. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

Other embodiments are set forth in the following claims.

What is claimed and desired to be secured by Letters Patent of the United States is:

1. A high efficiency fermentation method for converting nitrate to nitrite in food products, comprising the steps of:
providing a food product, wherein the food product comprises a fermentable liquid medium obtained and/or derived from an edible nitrate containing plant; and
controllably fermenting the food product such that nitrate to nitrite conversion results in nitrite concentration levels greater than approximately 3% by weight.

2. The method according to claim 1, wherein the step of providing a food product includes the step of providing a fermentation liquid obtained and/or derived from at least one of spinach, mustard greens, arugula, kale, swiss chard, lettuce, beetroot, beets, radishes, turnips, watercress, bok choy, Chinese cabbage, kohlrabi, chicory leaf, celery, carrots, onion, and garlic.

3. The method according to claim 1, wherein the step of providing a food product includes the step of providing a fermentation liquid obtained and/or derived from celery.

4. The method according to claim 1, wherein the step of providing a food product includes the step of providing a fermentation liquid obtained and/or derived from beets.

5. The method according to claim 1, wherein the step of controllably fermenting the food product results in nitrite concentration levels greater than approximately 5% by weight.

6. The method according to claim 1, wherein the step of controllably fermenting the food product results in nitrite concentration levels greater than approximately 7% by weight.

7. The method according to claim 1, wherein the step of controllably fermenting the food product results in nitrite concentration levels greater than approximately 9% by weight.

8. The method according to claim 1, wherein the step of controllably fermenting the food product results in nitrite concentration levels greater than approximately 10% by weight.

9. The method according to claim 1, further comprising the step of passing the food product through a first filter.

10. The method according to claim 9, wherein the step of passing the food product though a first filter includes the step of passing the food product through a ceramic membrane.

11. The method according to claim 9, wherein the step of passing the food product though a first filter includes the step of passing the food product through a ceramic membrane to separate bacteria and solids, and produce a dark brown clear solution.

12. The method according to claim 1, further comprising the step of passing the food product through a second filter.

13. The method according to claim 12, wherein the step of passing the food product though a second filter includes the step of direct filtration after the end of fermentation with live bacteria, with the process control temperature not exceeding 50° C., and when the proportion of filtrate volume reaches about 90%, initiating cleaning and washing with clear water, wherein the flow acceleration and filtration speed are approximately the same, and wherein the filtration is complete when the filtrate volume and stock liquid volume are equal.

14. The method according to claim 12, wherein the step of passing the food product though a second filter includes the step of direct filtration after the end of fermentation with live bacteria, with the process control temperature not exceeding 35° C., and the membrane pressure being approximately 10 MPa, and when the filtrate volume reaches 90% of the stock solution, the filtrate is washed with clear water until the volume of the transmitted liquid is equal to the volume of the stock solution.

15. The method according to claim 1, further comprising the step of controllably exposing the food product to ultra-high-temperature and/or electromagnetic radiation processing for a period of time, and at least one of pasteurizing, sanitizing, and sterilizing the food product.

16. The method according to claim 1, further comprising the step of controllably spray drying the food product at high-temperature.

17. A food product filtered according to the method of claim 1.
